(19) United States
(12) Patent Application Publication
(10) Pub. No.: US 2025/0367616 A1
(43) Pub. Date: Dec. 4, 2025

(54) fluid mixing device

(71) Applicant: Won Kee SUNG, Yongin-si, Gyeonggi-do (KR)

(72) Inventor: Won Kee SUNG, Yongin-si, Gyeonggi-do (KR)

(21) Appl. No.: 18/862,526

(22) PCT Filed: May 2, 2023
(86) PCT No.: PCT/KR2023/005934

§ 371 Date: Feb. 25, 2025

(30) Foreign Application Priority Data
May 2, 2022 (KR) 10-2022-0054396

(51) Int. Cl. B01F 25/452; B01F 23/45; B01F 25/00; B01F 35/00; B01F 35/213; B01F 35/52

(52) U.S. Cl. CPC B01F 25/4521; B01F 23/453; B01F 35/187; B01F 35/213; B01F 35/52; B01F 2025/918

(57) ABSTRACT

Provided is a fluid mixing device comprising: a chamber that provides a mixing space in which different types of fluids are introduced and mixed with one another and a storage space in which a mixture of the fluids mixed in the mixing space is stored; a mixing unit that is provided in the mixing space formed in the chamber to discharge and mix the different types of fluids; a measurement unit that is provided in the storage space provided in the chamber to measure physical property values of the fluid mixture stored in the storage space; and a discharge unit that discharges the fluid mixture stored in the storage space to the outside on the basis of measurement values measured by the measurement unit.

### TECHNICAL FIELD

The present invention relates to a fluid mixing device capable of mixing and supplying different types of fluids, and more specifically, to a fluid mixing device configured to mix different types of fluids in one space and also to measure characteristics of a mixture of the fluids.

### BACKGROUND ART

Fluid mixing devices that mix different types of fluids are applied in various industrial fields. For example, to produce a urea solution used in a semiconductor manufacturing process, a mixing device that mixes urea and ultrapure water is required.

As another example, a papermaking process involves a process of adding chemicals such as liquid maintenance aids to a liquid fluid substance such as a fibrous suspension and mixing them homogeneously and a mixing device is used in the process.

In addition, even in the case of hypochlorous acid water which has recently been in the spotlight as industrial washing water or sterilizing water, a mixing device that evenly mixes hydrochloric acid and water is used to supply diluted hydrochloric acid to a membrane-less electrolytic cell.

Fluid mixing devices that mix different types of fluids like this are used in various industrial fields.

However, since existing fluid mixing devices do not have a measurement configuration to check whether or not a fluid mixture satisfies physical property values, such as concentration, conductivity, temperature, and dissolved oxygen amounts, required by a place of use before the fluid mixture is supplied to the place of use, there is a problem that a manufacturing process of the fluid mixture is time-consuming and inconvenient.

In other words, since the mixing process of mixing different types of fluids and the measuring process of measuring the physical property values of the fluid mixture produced during the mixing process were performed separately in the past, it was difficult to supply the fluid mixture in a timely manner in response to the physical property values of the fluid mixture required by the place of use. In addition, the existing fluid mixing devices have a problem that adjusting the physical property values of the fluid mixture to the standards required by the place of use takes a long time and is inconvenient because the physical property values of the fluid mixture cannot be monitored in real time.

Thus, the applicant proposed the present invention to solve the above-described problems, and a related prior art document is “Medicine mixing device and method” disclosed in Korean Patent No. 10-0727851.

### DISCLOSURE

### Technical Problem

The present invention is intended to solve the above problems, and is directed to providing a fluid mixing device capable of mixing different types of liquids and immediately measuring physical property values of a fluid mixture.

Also, the present invention is directed to providing a fluid mixing device configured to monitor the physical property values of the fluid mixture in real time and immediately respond to needs in a place of use.

Also, the present invention is directed to providing a fluid mixing device configured so that a user can easily perform a calibration process of a measurement unit that measures the physical property values of the fluid mixture.

### Technical Solution

One aspect of the present invention provides a fluid mixing device including a chamber configured to provide a mixing space in which different types of fluids are introduced and mixed with one another and a storage space in which a mixture of the fluids mixed in the mixing space is stored, a mixing unit provided in the mixing space formed in the chamber to discharge and mix the different types of fluids, a measurement unit provided in the storage space provided in the chamber to measure physical property values of the fluid mixture stored in the storage space, and a discharge unit configured to discharge the fluid mixture stored in the storage space to the outside on the basis of measurement values measured by the measurement unit.

Further, the mixing space and the storage space may be partitioned by a partition wall provided to protrude from a bottom surface of the chamber toward a ceiling surface of the chamber, and the fluid mixture mixed in the mixing space may be introduced into the storage space through a passage formed between an upper end of the partition wall and the ceiling surface of the chamber.

Further, the mixing unit may include a discharge pipe having an injection port, into which the different types of fluids are injected, at an upper end portion thereof, and of which a remaining portion in a lengthwise direction is inserted into the mixing space to discharge the different types of fluids, and a plurality of mixing plates provided at predetermined intervals in the lengthwise direction of the discharge pipe and through which the different types of fluids discharged from a lower end of the discharge pipe pass in a process in which the different types of fluids flow backward.

Further, the plurality of mixing plates may include a plurality of guide paths through which the fluids discharged from a lower end of the discharge pipe and flowing to an upper portion of the chamber pass.

Further, the guide path may have a groove shape that cuts out a part of an area formed by the mixing plate, or may have a through hole shape.

Further, the guide paths provided in each of the plurality of mixing plates may be alternately disposed to increase a retention time of the fluid mixture flowing from a lower portion to an upper portion of the mixing space and also to change a flow direction of the fluid mixture.

Further, the measurement unit may measure the physical property values of the fluid mixture in a state in which the measurement unit is disposed in a measurement space provided in the chamber, the measurement space and the storage space may be partitioned by a vertical wall, and an inlet hole which guides the fluid mixture stored in the storage space to the measurement space may be provided in the vertical wall.

Further, a circulation hole may be provided in the vertical wall to guide the fluid mixture stored in the measurement space to the storage space when the fluid mixture introduced into the measurement space is stored to a certain level within the measurement space.

Further, the chamber may further include a calibration vent, and the calibration vent may be communicatively connected to the measurement space, and is formed at a position lower than a formation position of the inlet hole.

Further, the fluid mixing device may further include a filter through which the fluid mixture flowing from the mixing space to the storage space passes, and the filter may be disposed at a position lower than a passage formed between an upper end of the partition wall and the ceiling surface of the chamber, and may be supported by the partition wall and the vertical wall.

Further, the fluid mixing device may further include a temperature detection sensor that measures a temperature of the fluid mixture stored in the storage space, and may determine whether or not to discharge the fluid mixture by monitoring a temperature value detected by the temperature detection sensor and a measurement value measured by the measurement unit in real time.

Further, the discharge unit may include a first discharge port which discharges the fluid mixture stored in the storage space to the outside when the measurement value measured by the measurement unit does not satisfy a preset measurement value; a second discharge port which transmits the fluid mixture stored in the storage space to a large-capacity storage member when the measurement value measured by the measurement unit satisfies the preset measurement value; and a third discharge port which transmits the fluid mixture stored in the storage space to a large-capacity storage member when the measurement value measured in the above measurement unit satisfies the preset measurement value.

### Advantageous Effects

Since a fluid mixing device according to the present invention provides a configuration in which a space for mixing different types of fluids and a space for measuring physical property values are formed within a single chamber, an operator can monitor the physical property values of a fluid mixture in real time and can immediately adjust a mixing ratio of the fluid mixture or can supply it to a place of use based on the results.

Also, since the fluid mixing device according to the present invention provides a configuration for mixing different types of fluids while the different types of fluids flow backward, it is possible to increase a mixing property and it becomes easy to manufacture a fluid mixture having the physical property values desired by the user.

Furthermore, since the fluid mixing device according to the present invention can easily perform calibration work of the measurement unit using a calibration vent, the physical property values of the fluid mixture can be measured with high accuracy.

In addition, the fluid mixing device according to the present invention can discharge the fluid mixture stored in a storage space according to the purpose of use using a plurality of discharge ports that are communicatively connected to the storage space.

### DESCRIPTION OF DRAWINGS

FIG. 1 is a perspective view of a fluid mixing device according to one embodiment of the present invention.

FIG. 2 is a diagram showing the inside of the fluid mixing device according to one embodiment of the present invention.

FIG. 3 is a perspective view of a mixing unit according to one embodiment of the present invention.

FIG. 4 is a perspective view showing a mixing plate according to another embodiment of the present invention.

FIG. 5 is a perspective view of a measurement unit according to one embodiment of the present invention.

FIG. 6 is a perspective view of a filter and a vertical wall according to one embodiment of the present invention.

FIG. 7 is a diagram showing a flow process of a fluid mixture.

### MODES OF THE INVENTION

The advantages and features of the present invention and the methods of achieving them will become apparent with reference to the embodiments described below in detail together with the accompanying drawings.

However, the present invention is not limited to the embodiments presented below and may be implemented in various different forms, the embodiments are provided only to ensure that this disclosure of the present invention is complete and will fully convey the scope of the invention to those skilled in the art, and the invention is defined only by the scope of the claims.

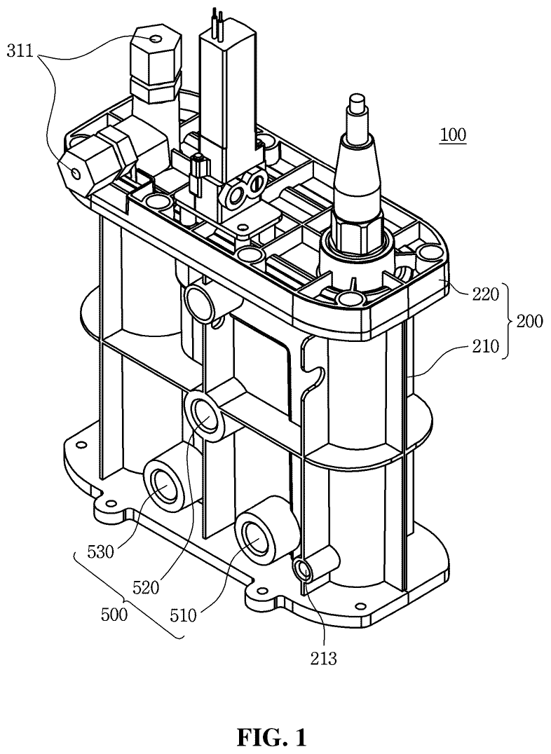

Hereinafter, a fluid mixing device according to one embodiment of the present invention will be described in detail with reference to FIGS. 1 to 7. In describing the present invention, specific descriptions of related known functions or configurations are omitted in order to avoid obscuring the gist of the invention.

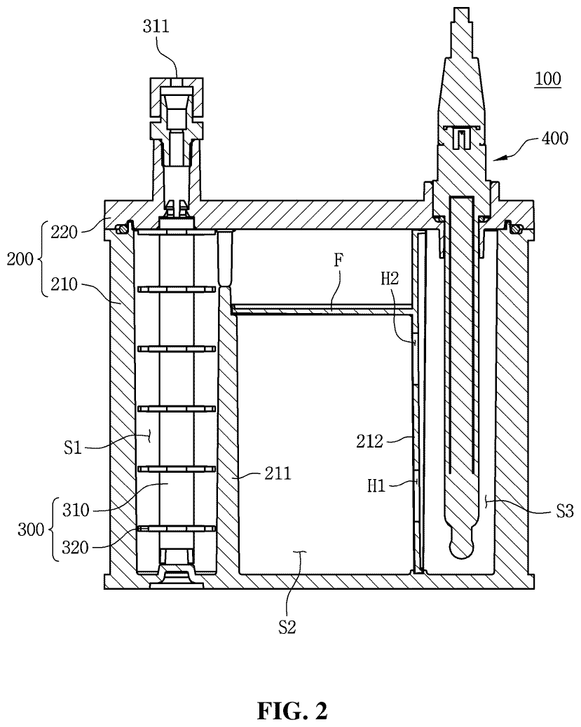

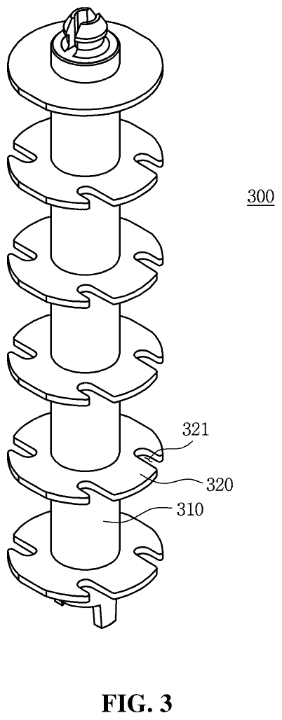

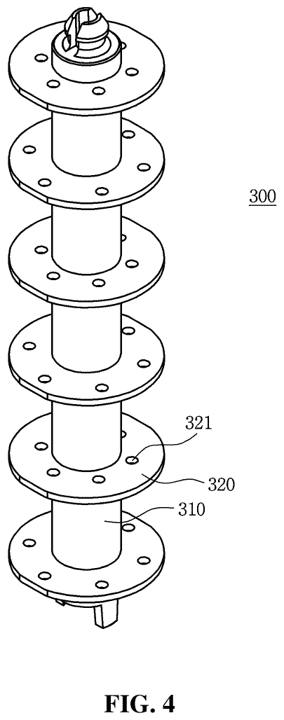

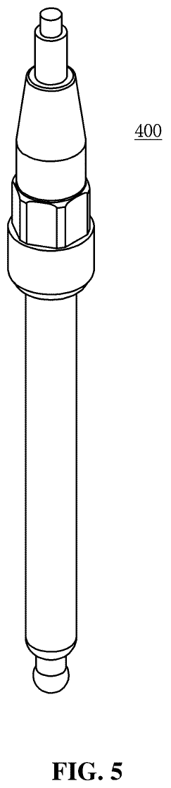

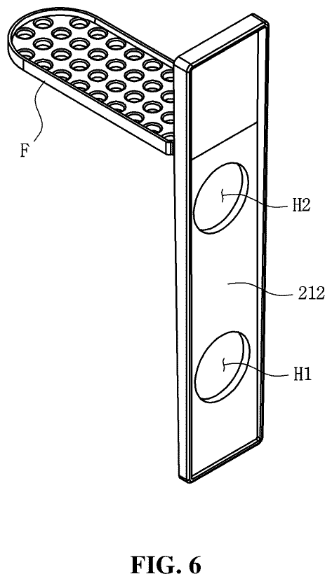

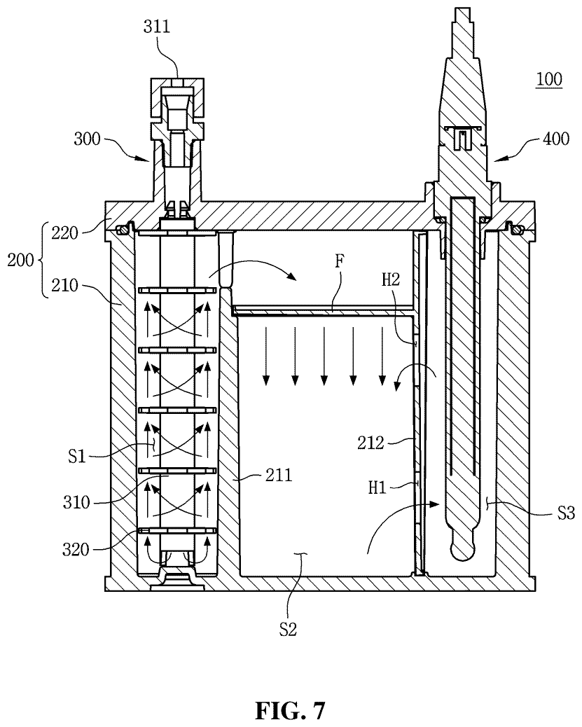

FIG. 1 is a perspective view of a fluid mixing device according to one embodiment of the present invention, FIG. 2 is a drawing showing the inside of the fluid mixing device according to one embodiment of the present invention, FIG. 3 is a perspective view of a mixing unit according to one embodiment of the present invention, FIG. 4 is a perspective view showing a mixing plate according to another embodiment of the present invention, FIG. 5 is a perspective view of a measurement unit according to one embodiment of the present invention, FIG. 6 is a perspective view of a filter and a vertical wall according to one embodiment of the present invention, and FIG. 7 is a drawing showing a flow process of a fluid mixture.

The fluid mixing device according to one embodiment of the present invention is characterized in that it is configured to mix, store, discharge, measure, and monitor different types of fluids within a single space.

As shown in FIGS. 1 and 2, a fluid mixing device 100 according to one embodiment of the present invention may include: a chamber 200 that provides a mixing space S1 in which different types of fluids are introduced and mixed with one another and a storage space S2 in which a mixture of the fluids mixed in the mixing space S1 is stored; a mixing unit 300 that is provided in the mixing space S1 formed in the chamber 200 to discharge and mix the different types of fluids; a measurement unit 400 that is provided in the chamber 200 to measure physical property values of the fluid mixture stored in the storage space S2; and a discharge unit 500 that discharges the fluid mixture stored in the storage space S2 to the outside on the basis of measurement values measured by the measurement unit 400.

As shown in FIGS. 1 and 2, the chamber 200 may include a main body 210 that provides a space in which different types of fluids may be mixed and stored, and a cover 220 that covers an open upper portion of the main body 210.

An internal space formed by the main body 210 may be divided into the mixing space S1, the storage space S2, and a measurement space S3, and the spaces may be partitioned by a partition wall 211 and a vertical wall 212 which will be described below.

The cover 220 is coupled to an upper end of the main body 210 to block the open upper portion of the main body 210. In addition, upper end portions of the mixing unit 200 and the measurement unit 400, which will be described below, are coupled to the cover 220.

As described above, the mixing space S1 and the storage space S2 are partitioned by the partition wall 211 that protrudes from a bottom surface of the main body 210 toward the cover 220.

At this time, a passage through which the fluid mixture mixed in the mixing space S1 may pass is provided between the partition wall 211 and the cover 220. That is, a gap is provided between an upper end of the partition wall 211 and the cover 220, and this gap serves as a passage through which the fluid mixture may flow. Therefore, the fluid mixture mixed in the mixing space S1 may be introduced into the storage space S2 through the passage formed between the upper end of the partition wall 211 and the cover 220.

As shown in FIGS. 2 to 4, the mixing unit 300 may include: a discharge pipe 310 having an injection port 311, into which different types of fluids are injected, at an upper end portion thereof and of which a remaining portion in a lengthwise direction is inserted into the mixing space S1 to discharge the different types of fluids; and a plurality of mixing plates 320 provided at predetermined intervals in the lengthwise direction of the discharge pipe 310 and through which the different types of fluids discharged from a lower end of the discharge pipe 310 pass in a process in which the different types of fluids flow backward.

The injection port 311 provided at the upper end of the discharge pipe 310 may branch according to the number of fluids to be mixed, as shown in FIG. 1.

The injection port 311 provided at the upper end of the discharge pipe 310 is exposed above the cover 220. In addition, as shown in FIG. 1, a plurality of injection ports corresponding to the number of fluids to be mixed may be provided. In one embodiment of the present invention, two injection ports 311 are shown as being provided to communicate with the discharge pipe 310, and a different type of fluid may be injected through each of the injection ports 311. For example, in order to produce sterilizing water of a certain concentration, low-concentration water may be injected into one injection port 311 and high-concentration sterilizing water may be injected into the other injection port 311. Then, a physical property value of the fluid mixture measured by the measurement unit 400 becomes the concentration.

The fluid passing through the injection port 311 and the discharge pipe 310 is discharged toward the bottom of the mixing space S1 through the lower end of the discharge pipe 310. Then, the different types of fluids may be filled from the bottom of the mixing space S1.

The different types of fluids filled from the bottom of the mixing space S1 pass through a plurality of mixing plates 320, and at this time, the fluids can be mixed while being stored for a predetermined time in a space formed between the plurality of mixing plates 320.

That is, when the different types of fluids discharged to the bottom of the mixing space S1 are filled from the bottom to the top of the mixing space S1, the time for filling to the top becomes stagnant as it is blocked by the mixing plate 320 provided in the discharge pipe 310, and the different types of fluids may be mixed in this process. Since this process is performed in the space between the plurality of mixing plates 320, the mixing efficiency of the fluid mixture can increase further from the bottom toward the top of the mixing space S1.

The mixing plate 320 may have a shape corresponding to a flat cross-sectional shape of the mixing space S1, and in one embodiment of the present invention, it is illustrated in the drawing as having an overall circular plate shape.

In addition, a gap of a predetermined interval may be formed between a circumferential surface of the mixing plate 320 and the inner wall and partition wall 211 of the main body 210 that partitions the mixing space S1 so that the fluid mixture can pass therethrough. That is, the circumferential surface of the mixing plate 320 may be disposed so as not to come into contact with the inner wall and the partition wall 211 of the main body 210 within the mixing space S1 to form a predetermined gap through which the fluid mixture may pass.

In addition, as shown in FIG. 3, a plurality of guide paths 321 through which the fluid discharged from the lower end of the discharge pipe 310 and flowing to the upper portion of the chamber passes are provided in the mixing plate 320.

Each of the guide paths 321 may be formed in an oval groove shape on the circumference of the mixing plate 320.

The fluid mixture introduced into the space between the plurality of mixing plates 320 may flow upward through the guide paths 321.

In addition, the guide paths 321 provided on each of the plurality of mixing plates 320 may be disposed to correspond to each other. That is, when seen from a plane, the guide paths 321 formed on each of the mixing plates 320 may be aligned with each other.

As another example, the guide paths 321 provided on each of the plurality of mixing plates 320 may be disposed so as not to correspond to each other. That is, when seen from a plane, the guide paths 321 formed on each of the mixing plates 320 may be misaligned with each other.

When the guide paths 321 provided on each of the plurality of mixing plates 320 are disposed to correspond to each other, a flow speed of the fluid mixture may be increased.

On the other hand, when the guide paths 321 provided on each of the plurality of mixing plates 320 are disposed not to correspond to each other, a flow direction of the fluid mixture may be changed to increase a retention time of the fluid mixture, and a vortex may be generated to enhance the mixing property of the fluid mixture.

Thus, the plurality of mixing plates 320 may be rotatably mounted on an outer surface of the discharge pipe 310 so that a user can selectively arrange the guide paths 321 provided on each of the mixing plates 320 to correspond to each other or not to correspond to each other.

Meanwhile, as shown in FIG. 4, the guide path 321 may be formed in the mixing plate 320 in the shape of a circular hole. The guide path 321 having a hole shape may also be disposed in various positions on the mixing plate 320 according to the user's intention. For example, the hole-shaped guide paths 321 formed on each of the plurality of mixing plates 320 may be disposed to correspond to each other or not to correspond to each other.

As illustrated in FIG. 7, the different types of fluids discharged into the mixing space S1 by the mixing unit 300 configured as described above may be introduced into the storage space S2 while being mixed with each other.

The measurement unit 400 is a component that measures physical property values of the fluid mixture flowing from the storage space S2 to the measurement space S3, and may be disposed in the measurement space S3 provided in the chamber 200, as shown in FIGS. 2, 5, and 7.

For example, the measurement unit 400 may measure a concentration, conductivity, dissolved oxygen amount, and the like of the fluid mixture introduced from the storage space S2 into the measurement space S3. In one embodiment of the present invention, the measurement unit 400 is described as measuring the concentration of the fluid mixture.

Meanwhile, the measurement space S3 in which the measurement unit 400 is disposed and the storage space S2 in which the fluid mixture is stored are partitioned by the vertical wall 212.

The vertical wall 212 may have a lower end connected to a bottom surface of the main body 210 and an upper end connected to a lower surface of the cover 220, as shown in FIGS. 2 and 6.

Additionally, in the vertical wall 212, an inlet hole H1 is provided to guide the fluid mixture stored in the storage space S2 to the measurement space S3.

In addition, a circulation hole H2 may be provided in the vertical wall 212 to guide the fluid mixture stored in the measurement space S3 to the storage space when the fluid mixture introduced into the measurement space S3 is stored to a certain level within the measurement space S3.

First, the inlet hole H1 may be provided on the lower end side of the vertical wall 212. Thus, the fluid mixture introduced into the storage space S2 may be introduced into the bottom side of the measurement space S3 through the inlet hole H1. Then, a measurement probe provided at a lower end of the measurement unit 400 may measure the concentration of the fluid mixture stored in the lower portion of the measurement space S3 through the inlet hole H1. For reference, preferably, the inlet hole H1 is disposed at a position higher than a formation position of a calibration vent 213 which will be described below so that a test solution injected into the measurement space S3 through the calibration vent 213 is not introduced into the storage space S2.

Additionally, when the fluid mixture of which the concentration is measured by the measurement unit 400 is stored to a certain level within the mixing space S3, and then reaches a position at which the circulation hole H2 is provided, the fluid mixture may be introduced back into the storage space S2 through the circulation hole H2.

In addition, as illustrated in FIG. 1, the fluid mixing device 100 according to one embodiment of the present invention may further include the calibration vent 213.

The calibration vent 213 may be said to be a component used to correct the accuracy of the measurement unit 400 before the measurement unit 400 measures the physical property values of a mixed solution, and more precisely, may be said to be a component used to inject a test solution having a certain concentration into the lower portion of the measurement space S3 in which the measurement probe is placed, or to suction the injected test solution.

The calibration vent 213 is provided in the main body 210 of the chamber 200, and, for example, a needle of a syringe for delivering a fluid, a hose for delivering a fluid, a catheter, or the like may be inserted thereinto.

Therefore, before the measurement unit 400 measures the physical property values of the fluid mixture, in order to test the accuracy of the measurement unit 400, the user may inject a test solution having a certain concentration into the inside of the measurement space S3 using the calibration vent 213.

When calibration work of the measurement unit 400 is completed, the user may also suction the solution injected into the measurement space S3 through the calibration vent 213.

Preferably, the calibration vent 213 is provided at a position lower than a lower end of the measurement probe, and furthermore, the calibration vent 213 is preferably provided at a position lower than a formation position of the inlet hole H1 provided on the lower end side of the vertical wall 212.

The filter F may be disposed at a position lower than a passage formed between the upper end of the partition wall 211 and the ceiling surface of the chamber 200, but may be supported by the partition wall 211 and the vertical wall 212.

The filter F may be implemented as a known pre-filter, carbon filter, medium filter, or HEPA filter, and may be configured to have a plurality of filtering holes through which a fluid may pass. Additionally, of course, the filtering holes may be formed in various sizes and patterns.

Therefore, since foreign substances in the fluid mixture flowing from the mixing space S1 to the storage space S2 are filtered out by the filter F, a pure fluid mixture may be stored in the storage space S2.

As shown in FIG. 1, the discharge unit 500 may have a first discharge port 510, a second discharge port 520, and a third discharge port 530.

The first discharge port 510, the second discharge port 520, and the third discharge port 530 are provided in the main body 210 of the chamber 200 and are communicatively connected to the storage space S2 to transmit the fluid mixture to the outside.

The first discharge port 510 may be used to discharge the fluid mixture stored in the storage space S2 to the outside when a measurement value measured by the measurement unit 400 does not satisfy a preset measurement value.

The second discharge port 520 may be used to transmit the fluid mixture stored in the storage space S2 to a large-capacity storage member when the measurement value measured by the measurement unit 400 satisfies the preset measurement value.

The third discharge port 530 may be used to transmit the fluid mixture stored in the storage space S2 to a large-capacity storage member when the measurement value measured by the measurement unit 400 satisfies the preset measurement value.

The first discharge port 510 is a component used to discard the fluid mixture stored in the storage space S2 when the fluid mixture stored in the storage space S2 does not satisfy preset physical property values.

The second discharge port 520 and the third discharge port 530 are components used to supply the fluid mixture to a place of use that requires the fluid mixture when the fluid mixture satisfies the preset physical property values.

The first discharge port 510, the second discharge port 520, and the third discharge port 530 are connected to hoses or pipes (not shown) for fluid transmission, and may of course be opened and closed by operations of valves. Therefore, the user may monitor the concentration of the fluid mixture measured in the measurement unit 400 in real time and then may operate the valve to discharge the fluid mixture to the outside according to the needs of the place of use.

Although specific embodiments of the present invention have been described so far, it is obvious that various modifications are possible within the scope of the present invention.

For example, the fluid mixing device 100 according to one embodiment of the present invention may further include a temperature detection sensor that measures a temperature of the fluid mixture stored in the storage space S2.

The temperature detection sensor may be provided separately in the storage space S2, or the measurement unit 400 may be configured to also function as a temperature detection sensor.

Therefore, the user may monitor the temperature value detected by the temperature detection sensor and the measurement value measured by the measurement unit 400 in real time to determine whether or not to discharge the fluid mixture.

Thus, the scope of the present invention should not be limited to the described embodiments, and should be defined not only by the scope of the claims below but also by equivalents of the claims.

1. A fluid mixing device comprising:
a chamber configured to provide a mixing space in which different types of fluids are introduced and mixed with one another and a storage space in which a mixture of the fluids mixed in the mixing space is stored;
a mixing unit provided in the mixing space formed in the chamber to discharge and mix the different types of fluids;
a measurement unit provided in the chamber to measure physical property values of the fluid mixture stored in the storage space; and
a discharge unit configured to discharge the fluid mixture stored in the storage space to the outside on the basis of measurement values measured by the measurement unit.

2. The fluid mixing device of claim 1, wherein the mixing space and the storage space are partitioned by a partition wall provided to protrude from a bottom surface of the chamber toward a ceiling surface of the chamber, and
the fluid mixture mixed in the mixing space is introduced into the storage space through a passage formed between an upper end of the partition wall and the ceiling surface of the chamber.

3. The fluid mixing device of claim 2, wherein the mixing unit includes:
a discharge pipe having an injection port, into which the different types of fluids are injected, at an upper end portion thereof and of which a remaining portion in a lengthwise direction is inserted into the mixing space to discharge the different types of fluids; and
a plurality of mixing plates provided at predetermined intervals in the lengthwise direction of the discharge pipe and through which the different types of fluids discharged from a lower end of the discharge pipe pass in a process in which the different types of fluids flow backward.

4. The fluid mixing device of claim 3, wherein the plurality of mixing plates include a plurality of guide paths through which the fluids discharged from the lower end of the discharge pipe and flowing to an upper portion of the chamber pass.

5. The fluid mixing device of claim 3, wherein the guide path has a groove shape that cuts out a part of an area formed by the mixing plate, or has a through hole shape. cm 6. The fluid mixing device of claim 5, wherein the guide paths provided in each of the plurality of mixing plates are alternately disposed to increase a retention time of the fluid mixture flowing from a lower portion to an upper portion of the mixing space and also to change a flow direction of the fluid mixture.

7. The fluid mixing device of claim 2, wherein the measurement unit measures the physical property values of the fluid mixture in a state in which the measurement unit is disposed in a measurement space provided in the chamber, and
the measurement space and the storage space are partitioned by a vertical wall, and an inlet hole which guides the fluid mixture stored in the storage space to the measurement space is provided in the vertical wall.

8. The fluid mixing device of claim 7, wherein a circulation hole is provided in the vertical wall to guide the fluid mixture stored in the measurement space to the storage space when the fluid mixture introduced into the measurement space is stored to a certain level within the measurement space.

9. The fluid mixing device of claim 7, wherein the chamber further includes a calibration vent, and
the calibration vent is communicatively connected to the measurement space, and is formed at a position lower than a formation position of the inlet hole.

10. The fluid mixing device of claim 7, further comprising a filter through which the fluid mixture flowing from the mixing space to the storage space passes,
wherein the filter is disposed at a position lower than a passage formed between the upper end of the partition wall and the ceiling surface of the chamber, and is supported by the partition wall and the vertical wall.
